(19) United States
(12) Patent Application Publication
(10) Pub. No.: US 2007/0257895 A1
(43) Pub. Date: Nov. 8, 2007

(54) TACTILE DISPLAY LOCKING AND MARKER SYSTEM

(75) Inventor: Michael Tolaio, Scotts Valley, CA (US)

Correspondence Address: ISHIMARU & ZAHRT LLP, 333 W. EL CAMINO REAL, SUITE 330, SUNNYVALE, CA, 94087, US

(73) Assignee: SUNRISE TELECOM INCORPORATED, San Jose, CA (US)

(21) Appl. No.: 11/746,052

(22) Filed: May 8, 2007

Related U.S. Application Data
(60) Provisional application No. 60/746,763, filed on May 8, 2006.

(51) Int. Cl. G06F 3/041

(52) U.S. Cl. 345/173

(57) ABSTRACT

A tactile display locking and marker system is provided including enabling a touch screen; contacting a marker lock soft key on the touch screen; and disabling the touch screen including only detecting the marker lock soft key activation on the touch screen

### CROSS-REFERENCE TO RELATED APPLICATIONS

This application claims the benefit of U.S. Provisional Patent Application Ser. No. 60/746,763, filed May 8, 2006.

### TECHNICAL FIELD

The present invention relates generally to any electronic equipment that conveys information and receives command through a tactile display, more particularly to a design and implementation aspects of the locking and marker system on a tactile display.

### BACKGROUND ART

Many forms of electronic equipment use a tactile display screen to communicate information to a user and receive input or command from the user. Test equipment such as a Logic Analyzer, a Spectrum Analyzer, a Digital Storage Oscilloscope (DSO), a Network Analyzer and the like have taken the lead in providing a tactile display system to simplify and enhance the user interface. Other consumer electronic equipment such as a Personal Digital Assistant (PDA), a Global Positioning System (GPS), a Smart Phone, or a Point Of Sale Terminal (POS) may also provide a tactile display as the user interface of choice. It is often desirable to disable the tactile display's sensitivity to touch in order to preserve the information on the screen. Since equipment having the tactile display uses a touch screen to receive input from a user, any contact with the touch screen may accidentally alter the information or data on the display.

Electronic touch screens that provide coordinate data regarding the location of an object being brought into proximity to a screen are well known. Typically, keypads are displayed on touch screens to receive user input for application programs. These keypads are comprised of a number of keys that are displayed on a screen. Each keypad typically is defined by two or more corner coordinates and/or length and width parameters. These keypad data define areas on the screen that correspond to particular keys. In response to an object being brought into proximity to the screen, the screen generates location coordinates for the ‘touch’ and a screen control program determines whether the coordinates of the ‘touch’ correspond to one of the defined keypad areas. If they do, the screen control program retrieves input data that correspond to the keypad area that was ‘touched’ and this input data are provided to an application program. Otherwise, no input data are recognized as being generated from the touch screen and exception processing may occur to indicate an erroneous touch to the user.

Typically, a touch screen generates coordinates for a location where an object is brought into proximity to the screen. The screen may be a resistive touch screen that is comprised of two planes of resistive material that are electrically insulated from one another and generally parallel to one another. To detect the location of a touch to the screen, a reference voltage is applied to one of the planes. This plane is called the ‘active’ plane. A location signal for a touch occurs when the force of the touch causes an electrical contact between the two planes and the voltage present at the other plane is measured. With linear resistance in the active plane, the location of the point of contact is directly proportional to the distance the contact point lies from the voltage source. This location gives the proportionate distance along the axis of the active plane. The voltage is then removed from the active plane and applied to the other plane. This action reverses the roles of the two planes so voltage measurement of the other plane provides a proportionate distance along the other axis.

Equipment having the tactile display and marker system may be used for analysis of critical data. During the capture and analysis of the data, there may be a reason to have further contact with the tactile display. Contacting the tactile display in an inappropriate position or time might cause the data to be altered or lost. Many precautionary processes have been implemented that make the loss of the data less likely. Some of these processes create an unnecessarily complicated data capture exercise.

Many of the latest biomedical diagnostic tools have the ability to capture physiological data and present it graphically on the tactile display. In some instances, this data may be critical to saving someone's life. An accidental alteration or loss of the data could have catastrophic results. Many schemes have been implemented to preserve this type of data. Some of the techniques actually delay the presentation of the data until it can be stored somewhere in the machine. These techniques add another layer of complexity to the data capture and analysis process.

Thus, a need still remains for an efficient tactile display locking and marker system that can be activated and operated simply and quickly. In view of the increasing demand for the tactile display used in industrial and consumer electronics equipment, it is increasingly critical that answers be found to these problems. Another aspect driving change is the ever-increasing need to save costs and improve efficiencies, makes it more and more critical that answers be found to these problems. Solutions to these problems have been long sought but prior developments have not taught or suggested any solutions and, thus, solutions to these problems have long eluded those skilled in the art.

### DISCLOSURE OF THE INVENTION

The present invention provides a tactile display locking and marker system including enabling a touch screen; contacting a marker lock soft key on the touch screen; and disabling the touch screen including only detecting the marker lock soft key activation on the touch screen

Certain embodiments of the invention have other aspects in addition to or in place of those mentioned or are obvious from the above. The aspects will become apparent to those skilled in the art from a reading of the following detailed description when taken with reference to the accompanying drawings.

### BRIEF DESCRIPTION OF THE DRAWINGS

FIG. 1 is a diagram of a tactile display locking and marker system in an embodiment of the present invention;

FIG. 2 is a flow chart of a marker locking system;

FIG. 3 is a flow chart of a marker activation system;

FIG. 4 is a flow chart of a marker state transitioning system; and

FIG. 5 is a flow chart of a tactile display locking and marker system for the operation of the tactile display locking and marker system, in an embodiment of the present invention.

### BEST MODE FOR CARRYING OUT THE INVENTION

The following embodiments of the present invention are described in sufficient detail to enable those skilled in the art to make and use the invention. It is to be understood that other embodiments would be evident based on the present disclosure, and that process or mechanical changes may be made without departing from the scope of the present invention.

In the following description, numerous specific details are given to provide a thorough understanding of the invention. However, it will be apparent that the invention may be practiced without these specific details. In order to avoid obscuring the present invention, some well-known circuits, system configurations, and process steps are not disclosed in detail. Likewise, the drawings showing embodiments of the apparatus/device are semi-diagrammatic and not to scale and, particularly, some of the dimensions are for the clarity of presentation and are shown greatly exaggerated in the drawing FIGS.

The term “horizontal” as used herein is defined as a plane parallel to the conventional plane or surface of the Earth, regardless of its orientation. The term “vertical” refers to a direction perpendicular to the horizontal as just defined. Terms, such as “above”, “below”, “bottom”, “top”, “side” (as in “sidewall”), “higher”, “lower”, “upper”, “over”, and “under”, are defined with respect to the horizontal plane. The term “on” means there is direct contact among elements. The term “system” as used herein means and refers to the method and to the apparatus of the present invention in accordance with the context in which the term is used. The term “processing” as used herein includes stamping, forging, patterning, exposure, development, etching, cleaning, and/or removal of the material or laser trimming as required in forming a described structure.

The terms keys and buttons are used interchangeably and should be construed broadly. The term physical buttons and hard keys may be used interchangeably. The term soft key may be thought of as a key on a touch screen that is activated by contacting the touch screen in the designated area of the soft key. The term soft key is to be in contrast with the term hard key. Hard keys may be thought of as physical three dimensional keys as opposed to virtual keys on the touch screen. Soft keys, i.e., a corresponding icon, for example, can be located at different positions on a display screen depending on the mode of operation or the actual operation being performed. Hard keys, by contrast, are generally fixed in a specific location, although the function associated with the hard key may be reassigned via various methods. Thus, the terms soft keys and hard keys have relative meaning and soft keys are generally associated with a display and hard keys are generally not.

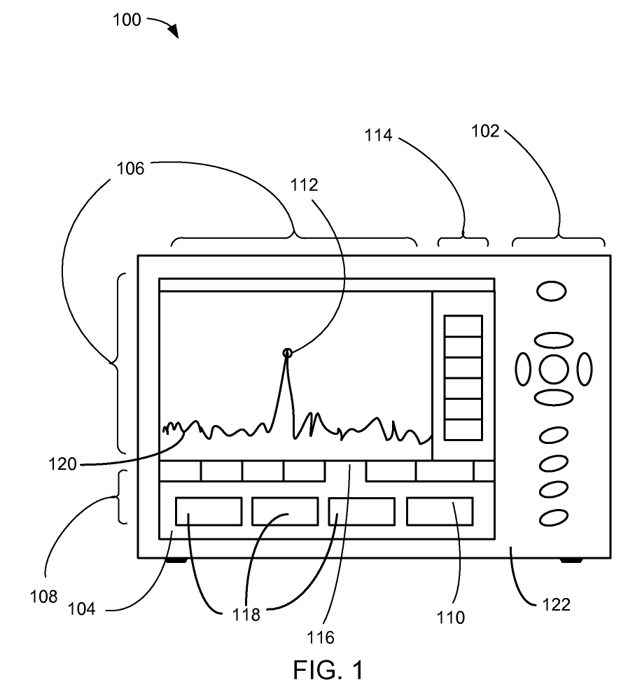

Referring to FIG. 1, therein is shown a diagram of a tactile display locking and marker system 100 in an embodiment of the present invention. The diagram of the tactile display locking and marker system 100 depicts hard keys 102, such as the power key, arrow keys, and function select keys, a touch screen 104 having a data display window 106, function soft keys 108, a marker lock soft key 110, a marker icon 112, marker soft keys 114, a marker function tab 116, marker control function keys 118, user data 120 and a chassis 122.

While test equipment is discussed for this application, other uses will be apparent from the teachings disclosed herein. The layout arrangement and the number of the hard keys 102 may vary depending on the function of the equipment. The touch screen 104 is a tactile display screen and it may be divided into sections. Inside the data display window 106, one or more of the marker icon 112 can be displayed when the marker function tab 116 is selected on the function soft keys 108. The marker icon 112 may use different symbols, color, display intensity, or a combination thereof to indicate marker state of either ACTIVE or ON. In this embodiment example, the ACTIVE marker icon is presented by a box symbol with a higher intensity than the surrounding marker icon. The ON but not ACTIVE marker is presented by a triangle symbol with a normal intensity. This is by way of an example and any combination of color, shape, and intensity that may differentiate the marker icon 112.

The number of the marker soft keys 114 indicates how many of the marker icon 112 can be on the data display window 106 at any time. In this embodiment example, there are six of the marker soft keys 114. Each of the marker soft keys 114 is numbered and associated with the marker icon 112 having the same number either next to or inside the marker symbol of either a box or a triangle. The color, shape, and intensity association helps a user to quickly identify the marker icon 112 active location and the marker soft keys 114 active which shows measured parameters on the marker location.

The function soft keys 108 comprise function tabs and each tab comprises several soft keys for that particular function. In this embodiment example, one of the tab functions is the marker function tab 116 that includes the marker lock soft key 110 and the marker control function keys 118. The marker control function keys 118 may be used to manipulate the position of the marker icon 112 relative to the user data 120. In this embodiment example, the touch screen 104 is locked and unlocked using the marker lock soft key 110. When the touch screen 104 is locked, the screen is not sensitive to a contact or touch, therefore the tactile display is in an inactive mode causing the touch screen to be disabled. A user is able to unlock the touch screen 104 with a soft key within the touch screen 104, instead of using any one of the hard keys 102 which is away from the user's field of view. If the user desires, various measurement settings may be altered for further data analysis without unlocking the markers. The marker lock soft key 110 is located inside the touch screen 104. In one embodiment example as shown in FIG. 1, the marker lock soft key 110 is placed at the bottom right of the data display window 106, within the touch screen 104. This makes user-to-system interaction more efficient because the user does not have to divert attention from the user data 120 on the touch screen 104 as the marker lock soft key 110 is within the user's field of view. The user can comprehend displayed data and quickly lock or unlock the touch screen 104. The reduced time enables the user to devote more time in analyzing the data on the data display window 106, thereby increasing the productivity overall.

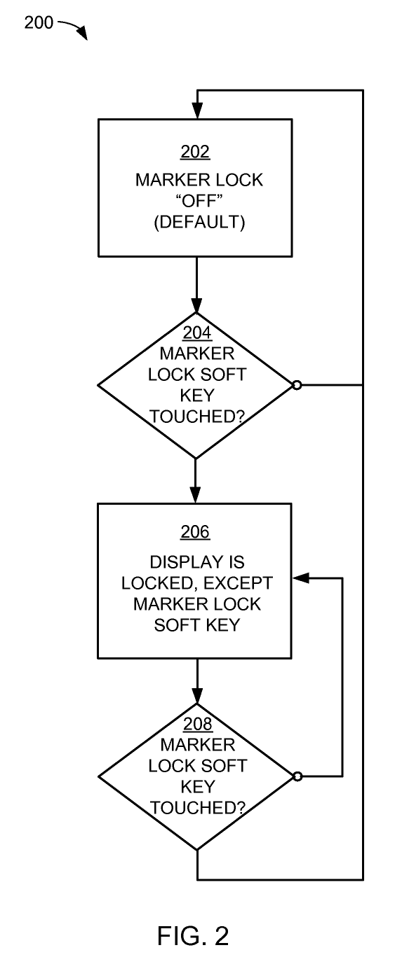

Referring now to FIG. 2, therein is shown a flowchart for a marker locking system 200. The flowchart of the marker locking system 200 illustrates an example of being able to lock and unlock the touch screen 104 of FIG. 1 with one of the function soft keys 108 of FIG. 1 within the touch screen 104 of FIG. 1.

While the marker function mode is selected, as a default operation, the marker lock feature is in an OFF state 202, which means the touch screen 104 in FIG. 1 is sensitive to a touch and enabled to accept inputs from the user. A first touch detected state 204 may monitor the status of the marker lock soft key 110. Touching the marker lock soft key 110 will cause the display screen to enter a locked state 206. This means the display screen is no longer sensitive to a touch and is not able to accept inputs from the user through the tactile display. The user may touch anywhere on the touch screen 104 without fear of accidentally altering the captured data on the data display window 106 in FIG. 1.

In order to reactivate the touch screen 104 to be tactilely sensitive again, the marker lock soft key 110 is monitored in a decision block 208. By touching the marker lock soft key 110 on the touch screen 104. The flow returns to the OFF state 202. The touch screen 104 is then unlocked and can accept input through contact with the touch screen 104. The user can continue with other activities such as, select different markers, turn on or off markers, or even start another measurement.

This may be achieved by creating software code that deactivates the display upon touch when the marker lock is in the locked state 206. The deactivation does not apply to the marker lock soft key 110 at any time. The software example is for demonstration purposes and it is clear that the functions discussed above may be implemented in hardware, software, or a combination thereof.

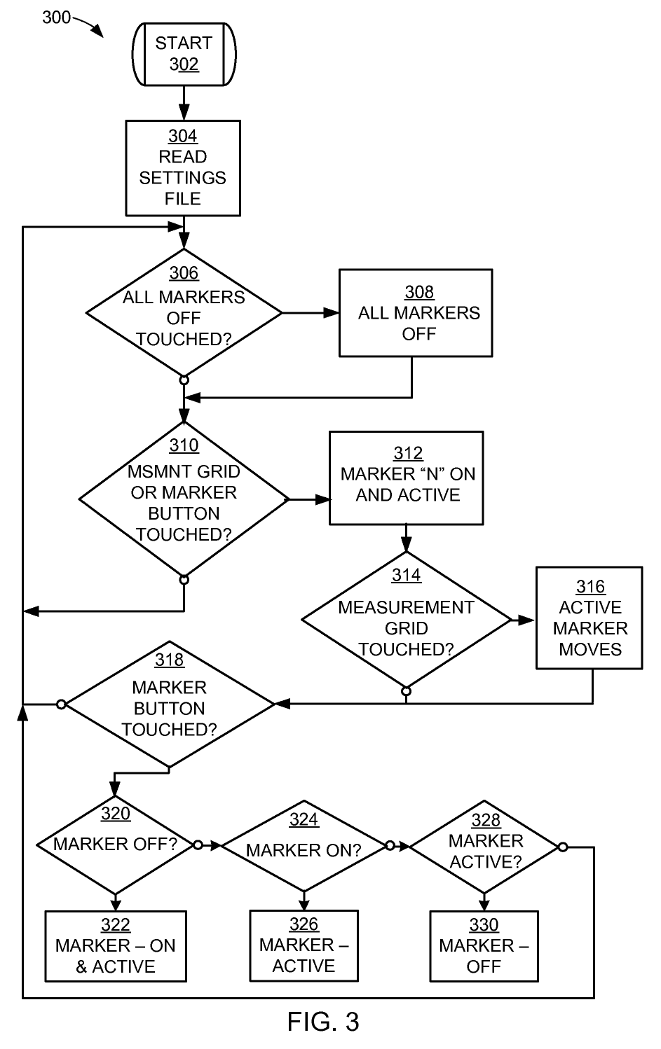

Referring now to FIG. 3, therein is shown a flowchart of a marker activation system 300. When the system is initially powered on, the marker function is not activated, and the marker soft keys 114 are not displayed as detailed in a START block 302. Information from a settings file is read by a control processor (not shown) in a Read Settings File block 304. A first decision block 306 may check for all markers off touched. If the all markers off soft key was touched, the flow progresses to an all markers off block 308. A second decision block 310 is entered from either the first decision block 306 or the all markers off block 308. The second decision block checks for the data display window 106 or the marker soft keys 114 having been touched. If neither have been touched, the flow returns to the first decision block 306. If they have been touched the marker “N” is set on and active in a marker active block 312.

A third decision block 314 checks for the data display window 106 having been touched. If the data display window 106 has not been touched, the flow proceeds to a fourth decision block 318. If the data display window has been touched the flow proceeds to an active marker moves block 316, then progresses to the fourth decision block 318. The fourth decision block 318 monitors for the marker soft keys 114 to be touched. If the marker soft keys 114 have not been touched the flow returns to the first decision block 306. If the marker soft keys 114 have been touched the flow proceeds to a fifth decision block 320 to check for the selected marker in the off state. If the selected marker is found to be off, the flow enters a marker on and active block 322.

If the selected marker is not off, the flow progresses to a sixth decision block 324 to check for the selected marker in an on state. If the selected marker is on, the flow progresses to a marker active block 326. If the selected marker is not on, the flow progresses to a seventh decision block 328 to check for the marker being active. If the selected marker is active the flow progresses to a marker off block 330 where the selected marker is turned off. If the selected marker is found not to be active, the flow returns to the first decision block 306.

At this time, all of the marker soft keys 114 are shown but only an initial marker becomes active. In this embodiment example, there may be six markers and six delta markers available for most measurement modes. The “active” marker will appear on the touch screen 104 as the marker icon 112 at the “touched” location, exhibiting a square box, colored and highlighted with the corresponding identifier character, such as a number, an identifying symbol, or a letter. The user data values will appear on the active, highlighted on the marker soft keys 114 on the touch screen 104. If necessary, the position of the marker can be changed by pressing the left/right arrow keys of the hard keys 102. In order to activate a marker other than the marker currently being displayed as “active”, simply touch one of the marker soft keys 114 to the right of the touch screen 104, this will be detected by the marker activation system 300. The new marker changes from its former “ON/OFF” status, to its new status as the “active marker”. This means that it can now be moved while the other markers remain in-place. The former “active” marker reverts to an “ON” status, but is no longer the “active” marker.

With “one touch” on the data display window 106, at a desired location in which measurement or parameter extraction is to be done, several events happen at the same time including opening the marker control tab, placing the marker icon 112 at the desired location, activating the marker soft keys 114, making the marker icon 112 the currently active, colored, and highlighted, and recording the user data 120 parameter at that location to be placed on the corresponding marker number of the marker soft keys 114.

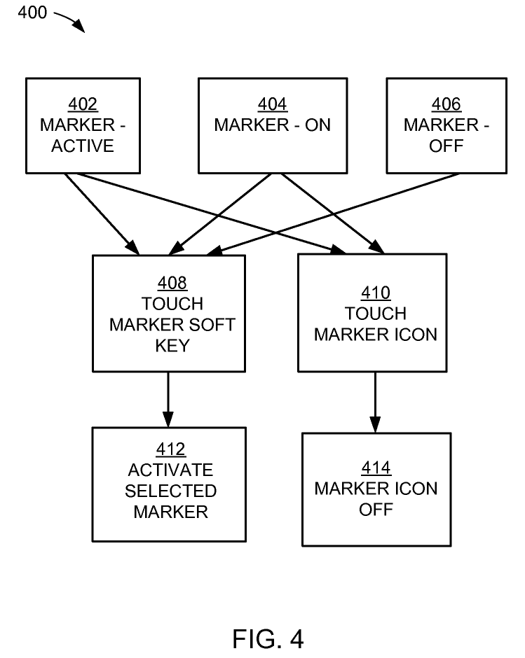

Referring to FIG. 4, therein is shown a flowchart of a Marker state transitioning system 400. The flow chart depicts three different states for the marker, i.e. an ACTIVE state 402, an ON state 404 and an OFF state 406. Transitioning marker's state will depend to what is being contacted on the touch screen 104. Whenever the data display window 106 is touched, regardless of what measurement menu the user is in, for example frequency, channel, amplitude, bandwidth, setup, or measure, once user touches that display, a marker is automatically activated and the marker menu is opened. Touching the data display window 106 again once a marker has been activated moves the marker to a new position on the screen.

In this embodiment example, six markers are available though any number of markers may be supported, only the marker soft keys 114 set to ACTIVE state will be highlighted in color; the markers soft keys 114 either in ON or OFF state will exhibit a different distinct color or white background with their respective marker number. To activate a marker other than the marker currently being displayed as “active”, simply touch one of the marker soft keys 114 to the right of the touch screen 104 as indicated in a touch marker soft key block 408. This will result in the new marker changing from its former ON or OFF state, to its new state as the “active marker”, in a activate selected marker block 412, meaning that it can now be moved while the other markers remain in-place. The former “active” marker reverts to an ON state, but is no longer the ACTIVE marker. For example to make marker number 4 active, simply touch the marker soft key 114; the button will be highlighted with a prescribed color, and the marker icon 112 symbol will appear on the screen highlighted with the prescribed color, and the pertinent data for that marker will appear on the now active, highlighted marker 4 button. To change the position of the marker for minor positioning adjustment, you can press the arrow keys on the hard keys 102.

In general, to position markers, touch the screen to make a rough placement, and then use the left/right arrow keys in the hard keys 102 to fine-tune the location, or open the marker function control tab 116, by touching marker soft keys 114 or the data display window 106, to conduct other marker functions such as Marker-to-Peak or Marker Delta.

To remove the marker icon 112 from the data display window 106, touch the marker icon 112 that corresponds to the marker to be removed in a touch marker icon block 410. The marker icon 112 will disappear and the marker soft key 114, of the corresponding marker icon, turns to a marker icon OFF block 414. The next time that the marker is activated it will appear at its previous location on the screen. To remove all markers at once, open the marker function tab 116 and touch All-Markers-Off function in the marker control function keys 118.

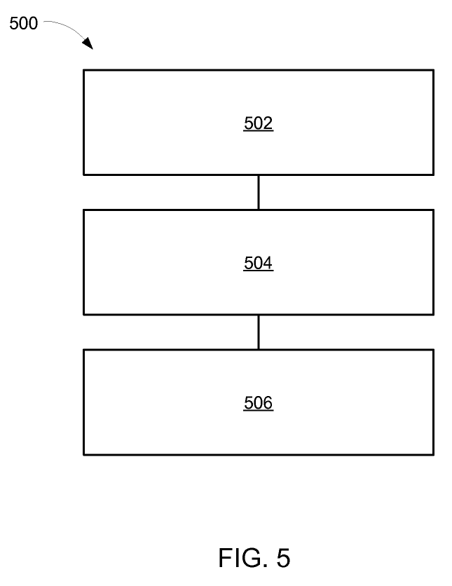

Referring now to FIG. 5, therein is shown a flow chart of a tactile display locking and marker system 500 for the operation of the tactile display locking and marker system 100 in an embodiment of the present invention. The system 500 includes enabling a touch screen in a block 502; contacting a marker lock soft key on the touch screen in a block 504; and disabling the touch screen including only detecting the marker lock soft key activation on the touch screen in a block 506.

An important aspect of the present invention is that it employs a direct touch of the marker icon to reduce the number of key strokes and steps for transitioning between markers to be activated, and provide a well-organized control with visual enhancement for the complex transition of three state marker modes.

These and other valuable aspects of the present invention consequently further the state of the usability, efficiency and responsiveness to at least the next level of enhancing user interface experience in tactile display equipment.

Thus, it has been discovered that the tactile display locking and marker system of the present invention furnish important and heretofore unavailable method and functional aspects for enhancing user interface of tactile display equipped electronics equipment. The resulting processes and configurations are straightforward, cost-effective, uncomplicated, highly versatile, accurate, sensitive, and effective, and can be implemented by adapting known components for ready, efficient, and economical manufacturing, application, and utilization.

While the invention has been described in conjunction with specific best mode using test equipment as embodiment example, it is to be understood that many alternatives, modifications, and variations will be apparent to those skilled in the art in light of the aforegoing description. Accordingly, it is intended to embrace all such alternatives, modifications, and variations which fall within the scope of the included claims. All matters heretofore set forth herein or shown in the accompanying drawings are to be interpreted in an illustrative and non-limiting sense.

What is claimed is:

1. A tactile display locking and marker system comprising:
enabling a touch screen;
contacting a marker lock soft key on the touch screen; and
disabling the touch screen except for enabling the touch screen through the marker lock soft key.

2. The system as claimed in claim 1 further comprising:
contacting a marker function tab on the touch screen for displaying the marker lock soft key.

3. The system as claimed in claim 1 further comprising:
activating a marker function tab on the touch screen for manipulating a marker icon on the touch screen.

4. The system as claimed in claim 1 further comprising:
displaying a marker icon on the touch screen; and
switching the marker icon between active, on, and off modes.

5. The system as claimed in claim 1 further comprising:
displaying marker soft keys on the touch screen; and
highlighting a marker icon, in a data display window, when contacting the marker soft keys wherein highlighting the marker icon includes:
enhancing the marker icon by adding a shape, a color, an intensity, an identifier character, or a combination thereof; and
displaying user data values on the marker soft keys.

6. A tactile display locking and marker system comprising:
enabling a touch screen having user data, function soft keys or a combination thereof;
contacting a marker lock soft key on the touch screen; and
disabling the touch screen except for enabling the touch screen through the marker lock soft key in which disabling the touch screen includes preventing a change of the user data.

7. The system as claimed in claim 6 further comprising:
contacting a marker function tab on the touch screen for displaying the marker lock soft key including displaying marker control function keys.

8. The system as claimed in claim 6 further comprising:
activating a marker function tab on the touch screen for manipulating a marker icon on the touch screen including positioning the marker icon on the user data.

9. The system as claimed in claim 6 further comprising:
displaying a marker icon on the touch screen; and
switching the marker icon between active, on, and off modes including providing a distinctive shape, color, intensity, or a combination thereof.

10. The system as claimed in claim 6 further comprising:
displaying marker soft keys on the touch screen;
highlighting a marker icon, in a data display window, when contacting the marker soft keys wherein highlighting the marker icon includes:
enhancing the marker icon by adding a shape, a color, an intensity, an identifier character, or a combination thereof; and
displaying the user data values on the marker soft keys including identifying the user data value in the marker soft key by the shape, the color, the intensity, the identifier character, or the combination thereof.

11. A tactile display locking and marker system comprising:
a touch screen;
a circuit for providing a marker lock soft key on the touch screen in which the circuit may disable the touch screen including only detecting the marker lock soft key activation on the touch screen.

12. The system as claimed in claim 11 further comprising:
a hard key for activating the touch screen.

13. The system as claimed in claim 11 further comprising:
a circuit to control a marker icon on the touch screen.

14. The system as claimed in claim 11 further comprising:
a circuit for switching a marker icon, on the touch screen, between active, on, and off modes.

15. The system as claimed in claim 11 further comprising:
a circuit for highlighting a marker icon in a data display window of the touch screen wherein the marker icon includes:
the marker icon enhanced by a shape, a color, an intensity, an identifier character, or a combination thereof; and
user data values displayed on the marker soft keys.

16. The system as claimed in claim 11 further comprising:
a chassis having the touch screen mounted therein.

17. The system as claimed in claim 16 further comprising:
a hard key on the chassis for activating the touch screen includes a power hard key, an arrow hard key, a select hard key, or a combination thereof.

18. The system as claimed in claim 16 further comprising:
a circuit to control a marker icon on the touch screen in which the circuit may control more than one of the marker icon.

19. The system as claimed in claim 16 further comprising:
a circuit for switching a marker icon, on the touch screen, between active, on, and off modes includes the marker icon state displayed on the marker soft key.

20. The system as claimed in claim 16 further comprising:
a circuit for highlighting a marker icon in a data display window of the touch screen wherein the marker icon includes:
the marker icon enhanced by a shape, a color, an intensity, an identifier character, or a combination thereof; and
user data values displayed on the marker soft keys; and
the circuit is hardware, software, or a combination thereof.
